(19) United States
(12) Patent Application Publication
(10) Pub. No.: US 2021/0120412 A1
(43) Pub. Date: Apr. 22, 2021

(54) ZERO-TOUCH PROVISIONING OF INTERNET OF THINGS DEVICES

(71) Applicant: MICROSOFT TECHNOLOGY LICENSING, LLC, Redmond, WA (US)

(72) Inventors: John David BRUNER, Bellevue, WA (US); Shai GUDAY, Redmond, WA (US); Jean KHAWAND, Sammamish, WA (US); Dhanya Krishnan NAIR, Redmond, WA (US); Paul Wayne IRWIN, Everett, WA (US); Sohail A. HIRANI, Redmond, WA (US)

(21) Appl. No.: 16/659,514

(22) Filed: Oct. 21, 2019

(51) Int. Cl. H04W 12/06

(52) U.S. Cl. CPC H04W 12/0609

(57) ABSTRACT

An internet of things (“IoT”) device is disclosed that can be authenticated on a wireless local area network (“WLAN”) without human intervention. The IoT device can also authenticate itself with a network service without human intervention. In order to enable this functionality, data identifying a service set identifier (“SSID”) used by the WLAN, a digital certificate for use in authenticating on the WLAN, and a digital certificate for use in authenticating with a network service are stored in the IoT device at the time it is manufactured. The digital certificate for authenticating on the WLAN is stored at an authentication server and information about the digital certificate for use in authenticating with the network service is stored at the network service. The IoT device can use the SSID to connect to the WLAN and use the digital certificates to authenticate with the authentication server and the network service, respectively.

### BACKGROUND

More computing devices are connected to the internet today than ever before. Many of these devices are Internet of Things (“IoT”) devices. IoT devices are computing devices that feature an internet protocol (“IP”) address for enabling internet connectivity and the communication that occurs between IoT devices and other internet-connected devices and systems.

IoT devices include a diverse range of computing devices and everyday objects that utilize embedded technology to communicate and interact with the external environment via the internet. Examples of IoT devices include, but are not limited to, connected security systems, thermostats, cars, electronic appliances, lights in household and commercial environments, alarm clocks, speaker systems, vending machines, voice-driven devices, and others.

Certain IoT installations can include thousands, tens of thousands, or even hundreds of thousands of IoT devices. In these types of installations, it can be practically impossible to configure IoT devices for connectivity to the internet and relevant network services. For example, using current technologies an administrator must manually configure each IoT device individually for network connectivity while located in physical proximity to the devices. At scale, this type of manual configuration is simply not practical.

Additionally, manual configuration of IoT devices commonly requires specialized hardware to be present in IoT devices. For instance, some configuration methods require the utilization of Bluetooth or near-field communication (“NFC”). The inclusion of hardware supporting these technologies can add additional cost to IoT devices and unnecessarily consume power after the devices have been configured. It is with respect to these and other technical challenges that the disclosure made herein is presented.

### SUMMARY

Technologies are disclosed herein for zero-touch provisioning of IoT devices. Through implementations of the disclosed technologies, IoT devices can be configured for network connectivity in a manner that does not require an administrator to be physically proximate to the devices. IoT devices implementing the disclosed technologies also do not require configuration from a remote location. This process might be described herein as “zero-touch configuration” or “zero-touch provisioning” since there is no need for an administrator to interact with IoT devices to configure them.

Additionally, because Bluetooth, NFC, or other types of specialized hardware is not utilized to configure the IoT devices, hardware used only for device configuration can be removed from IoT devices, thereby reducing both the cost and power consumption of these devices. Other technical benefits not specifically mentioned herein can also be realized through implementations of the disclosed subject matter.

In order to realize the technical benefits mentioned briefly above, and potentially others, an IoT device is provided that can authenticate itself for communication on a wireless local area network (“WLAN”) without human intervention. In some embodiments, the IoT device can also authenticate itself with a network service without human intervention once the IoT device has authenticated itself on the WLAN. In some embodiments, the authentication server is hosted within the WLAN. In other embodiments, the authentication server is hosted within a network services provider network, such as that described below.

In order to provide the functionality described briefly above, and in further detail below, data identifying a service set identifier (“SSID”) for a WLAN is stored in an IoT device. The SSID can be stored in the IoT device at the time the device is manufactured, for example. When the IoT device is subsequently powered on, the device searches for a WLAN having an SSID that is the same as the SSID that was stored in the device at manufacturing time. If a WLAN is located that has a matching SSID, the IoT device establishes a connection to the WLAN.

Once the IoT device has established a connection to a WLAN, the IoT device authenticates with an authentication server, such as an accounting, authorization, and accounting (“AAA”) server. In order to enable the IoT device to authenticate with the authentication server, a digital certificate is also stored in the IoT device at manufacturing time. The same digital certificate is also added to a list of allowed devices on the authentication server.

In order to authenticate on the WLAN, the IoT device establishes a connection to the authentication server. The IoT device then authenticates itself with the server using the previously-stored digital certificate in a public key infrastructure (“PKI”) authentication procedure. If authentication is successful, the authorization server authorizes the IoT device for communication on the WLAN and for communication with other networks accessible by way of the WLAN, such as the internet.

Once the IoT device has been authenticated, the IoT device can establish connections to certain network services, such as network services accessible by way of the internet. In order for the IoT device to authenticate with such a network service, another digital certificate is stored in the IoT device, also at the time the device is manufactured. Information about the digital certificate, such as a thumbprint, can also be provided to the network service. The IoT device can provide this digital certificate to the network service during a PM authentication process in order to authenticate itself

In one embodiment, the IoT device establishes a connection to a device provisioning service (“DPS”) operating in a network services provider network following authentication on a WLAN. The IoT device then provides a digital certificate to the DPS for use in authenticating the IoT device in a PM authentication procedure. During this process, the DPS utilizes the digital certificate and the previously received information about the digital certificate (e.g. the thumbprint) to determine if the IoT device can be authenticated.

If the DPS can authenticate the IoT device, the DPS then provides configuration data to the IoT device for use in configuring the IoT device for operation on the network services provider network. For instance, the configuration data might be used to configure the IoT device for operation with other network services in the network services provider network. For example, and without limitation, once configured the IoT device might establish a connection with a network service that provides functionality for managing the operation of IoT devices (which might be referred to herein as an “IoT device management service”). The IoT device can also establish connections with other types of network services in the network services provider network once authenticated by the DPS.

It should be appreciated that the subject matter disclosed herein can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram that shows aspects of operations performed to configure an IoT device, according to one embodiment;

FIG. 2 is a timing diagram showing aspects of the configuration of an IoT device implementing the disclosed technologies at manufacturing time, according to one embodiment disclosed herein;

FIG. 3 is a timing diagram showing aspects of the configuration of a wireless local area network and a network services provider network implementing aspects of the disclosed technologies, according to one embodiment disclosed herein;

FIG. 4A is a timing diagram showing aspects of the configuration of an IoT device for network connectivity, according to one embodiment disclosed herein;

FIG. 4B is a timing diagram showing aspects of the configuration of an IoT device for network connectivity, according to another embodiment disclosed herein;

FIG. 5 is a flow diagram showing a routine that illustrates aspects of the configuration and operation of an IoT device, a wireless local area network, and a services provider network that together implement aspects of the disclosed technologies, according to one embodiment disclosed herein;

FIG. 6 is a computer architecture diagram illustrating an illustrative computer hardware and software architecture for a computing system capable of implementing aspects of the techniques and technologies presented herein;

FIG. 7 is a network diagram illustrating an illustrative distributed computing environment capable of implementing aspects of the techniques and technologies presented herein; and

FIG. 8 is a computer architecture diagram illustrating a computing device architecture for a computing device capable of implementing aspects of the techniques and technologies presented herein.

### DETAILED DESCRIPTION

The following detailed description is directed to technologies for zero-touch provisioning of IoT devices. As will be described in greater detail below, computing devices implementing the disclosed technologies can be configured for network connectivity and for interaction with a services provider network with no manual user interaction required. As a result, significant time savings for administrators can be realized. Additionally, and as mentioned above, because specialized hardware is not utilized to configure the IoT devices as in conventional configurations, this hardware can be removed from the devices, thereby reducing cost and power consumption. Other technical benefits not specifically identified herein can also be realized through implementations of the disclosed technologies.

While the subject matter described herein is primarily presented in the context of an IoT device, those skilled in the art will recognize that the disclosed technologies can be utilized with other types of computing devices that require network connectivity. Those skilled in the art will also appreciate that the subject matter described herein can be practiced with various computer system configurations, including hand-held devices, multiprocessor systems, microprocessor-based or programmable consumer electronics, computing or processing systems embedded in devices (such as wearable computing devices, automobiles, home automation etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for zero-touch configuration of IoT devices will be described.

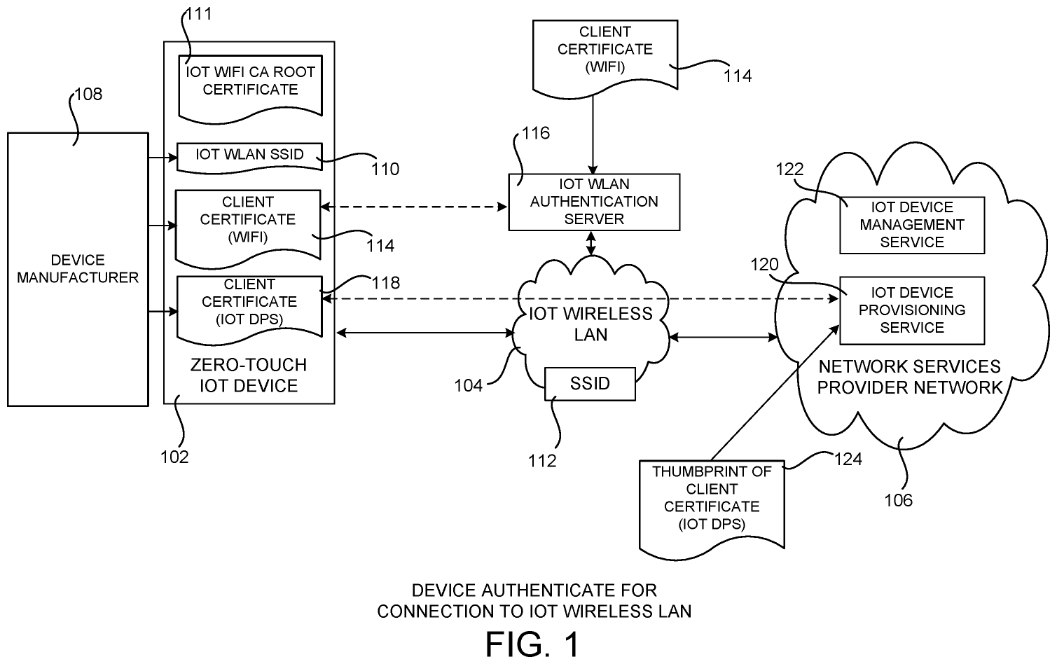

FIG. 1 is a network architecture diagram that shows aspects of operations performed to configure IoT devices, such as the zero-touch IoT device 102 (which will be referred to herein as the “IoT device 102” or the “device 102” for simplicity) shown in FIG. 1, according to one embodiment disclosed herein. In this regard, it is to be appreciated that while the technologies disclosed herein are presented in the context of an IoT device 102, the disclosed subject matter can be utilized with any type of computing device equipped with an appropriate network interface, such as those described below. Accordingly, the term IoT device as used herein is not limited to any particular type of computing device.

As will be described in greater detail below, the disclosed technologies enable the IoT device 102 to be configured for communication on a WLAN 104 without manual configuration. Additionally, aspects of the disclosed technologies can also be used to configure the IoT device 102 for use with a network services provider network 106 (“services provider network 106” or “network 106”), also without manual intervention. Details regarding these technologies will be described in greater detail below.

Before discussing the particular operations performed for zero-touch configuration of the IoT device 102, details will be provided regarding one operating environment for the disclosed technologies. In particular, the operating environment shown in FIG. 1 includes a WLAN 104. The WLAN 104 is a wireless network provided by various hardware components such as, but not limited to, wireless access points (“WAPs”). The WAPs can send and receive data over various electromagnetic frequencies (e.g., radio frequencies). WAPs might be utilized, for example, that support Institute of Electrical and Electronics Engineers (“IEEE”) 802.11 standards (e.g., 802.11g, 802.11n, and so forth), or other standards. The WLAN 104 can be identified by a service set identifier (“SSID”) 112.

The IoT device 102 includes one or more network interfaces capable of connecting the IoT device 102 to the WLAN 104. Such network interfaces can include, but are not limited to, wireless network interface controllers (“NICs”) or other types of transceiver devices capable of sending and receiving data over the WLAN 104.

As shown in FIG. 1, the WLAN 104 can be used to access a network services provider network 106 by way of the internet in one embodiment. In order to enable access to the network services provider network 106 by way of the WLAN 104, various networks not shown in FIG. 1 might be utilized. For example, and without limitation, public networks such as the internet, private networks such as an institutional and/or personal intranet, or some combination of private and public networks might be utilized.

The WLAN 104 and the network services provider network 106 can utilize communications protocols, including packet-based and/or datagram-based protocols such as Internet protocol (“IP”), transmission control protocol (“TCP”), user datagram protocol (“UDP”), or other types of protocols. Moreover, the WLAN 104 and the network services provider network 106 can also include a number of devices (not shown in FIG. 1) that facilitate network communications and/or form a hardware basis for the networks, such as switches, routers, gateways, access points, firewalls, base stations, repeaters, backbone devices, and the like.

The network services provider network 106 (which might be referred to herein as the “network 106”) is a network accessible via the internet that is provided by a network services provider. The network 106 provides computing resources and network services to clients such as, but not limited to, the IoT device 102. The computing resources provided by the network 106 can, for example, be data processing resources, such as virtual machine (“VM”) instances, data storage resources, networking resources, data communication resources, network services, and other types of resources.

The computing resources and network services enabled by the network 106 are provided in one implementation by computing devices located in one or more data centers (not shown in FIG. 1). Data centers are facilities utilized to house and operate computer systems and associated components. Data centers also typically include redundant and backup power, communications, cooling, and security systems, in addition to many other components. Multiple data centers in geographically disparate locations can be utilized to provide the network 106.

The network services provided by the network 106 can include, but are not limited to, services providing VMs, web sites, network-accessible storage, databases, messaging functionality, IoT monitoring and management services, machine learning services, for creating and managing virtual networks, and many others. Examples of network services provider networks 106 include, but are not limited to, the AMAZON WEB SERVICE cloud computing network, the MICROSOFT AZURE cloud computing network, the GOOGLE CLOUD PLATFORM, the IBM CLOUD, and the ORACLE CLOUD. The technologies disclosed herein can be utilized in conjunction with these environments and others.

Specific network services utilized by the embodiments disclosed herein include an IoT device provisioning service (“DPS”) 120 and an IoT device management service 122. In addition to other types of functionality, the DPS 120 is configured to authenticate computing devices, such as the IoT device 102. Once the DPS 120 has authenticated a computing device, the DPS 120 can provide configuration data to the device to configure the device for use with the network 106.

Once authenticated, devices can utilize network services within the network 106. For instance, once authenticated the IoT device 102 can connect to and utilize services provided by the IoT device management service 122. The IoT device management service 122 provides functionality for enabling secure communication between an application executing in the network 106 and IoT devices, such as the IoT device 102. The IoT device management service 122 can also provide device management functionality, scalable data ingestion, device control and management, or health monitoring, among other services relating to the configuration and operation of IoT devices. Once authenticated by the DPS 120, devices might also be authorized to utilize other network services provided by the network 106 such as those described above.

As shown in FIG. 1, an authentication server 116, such as a AAA server, is connected to the WLAN 104. For example, and without limitation, the authentication server 116 might be located in physical proximity to the WLAN 104 and connected to the WLAN 104 in order to authenticate computing devices, such as the IoT device 102, for operation on the WLAN 104. In other embodiments, the authentication server 116 is hosted within the network services provider network 106. Additional details regarding the operation of the authentication server 116 will be provided below.

In order to provide the functionality described briefly above, and in further detail below, a manufacturer 108 of the IoT device 102 stores data 110 identifying a SSID for a WLAN in a memory of the IoT device 102. The data 110 identifying the SSID can be stored in the memory of the IoT device 102 at the time the device is manufactured, for example.

When the IoT device 102 is powered on, the device 102 searches for a WLAN 104 having an SSID 112 that is the same as the SSID that was stored in the device 102 at manufacturing time. If a WLAN 104 is located that has a matching SSID, the IoT device 102 establishes a connection to the WLAN 104. In the example shown in FIG. 1, for instance, the SSID defined by the data 110 stored in the IoT device 102 matches the SSID 112 and, accordingly, a connection is established between the IoT device 102 and the WLAN 104.

Once the IoT device 102 has established a connection to the WLAN 104, the IoT device 102 authenticates with the authentication server 116 using an appropriate protocol such as, but not limited to, EAP-TLS. In order to enable the IoT device 102 to authenticate with the authentication server 116, the manufacturer 108 of the device 102 also stores a client digital certificate 114 (referred to herein as the “digital certificate 114”) in the memory of the IoT device 102 at manufacturing time. The digital certificate 114 might, for example, be an X.509 certificate. The digital certificate 114 can be signed by any certificate authority, such as the device manufacturer 108.

The digital certificate 114 stored in the IoT device 102 is also separately provided to the operator of the authentication server 116 which, in turn, adds the digital certificate 114 to an allow list maintained by the authentication server 116. The allow list includes digital certificates for client devices that are permitted to connect to the WLAN 104. The authentication server 116 also has a server certificate (not shown in FIG. 1) signed by a certificate authority. Additionally, the manufacturer 108 of the IoT device 102 also stores a root certificate 111 for the certificate authority in the memory of the IoT device 102.

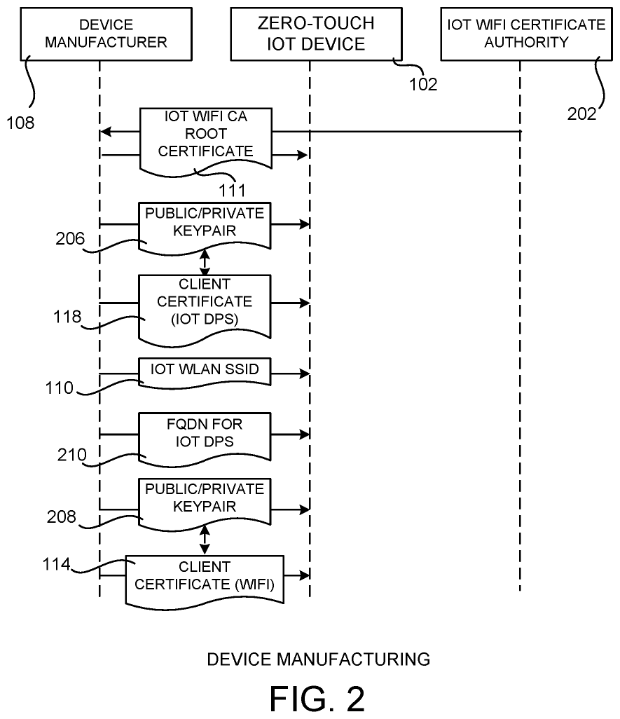

The IoT device 102 establishes a connection to the authentication server 116 via the WLAN 104 and performs public encryption key infrastructure (“PKI”) authentication with the authentication server 116 in order to authenticate on the WLAN 104. In order to perform PM authentication, the IoT device 102 stores a matched pair of asymmetric encryption keys (shown in FIG. 2): a private encryption key that is known only to the IoT device 102 (and never exposed) and a corresponding public encryption key, which is contained in the device's certificate (e.g. the certificates 114 and 118).

In order to authenticate the IoT device 102, the authentication server 116 challenges the IoT device 102 by issuing a request that includes a random number generated by the authentication server 114. In response thereto, the IoT device 102 creates a response that includes the random number received from the authentication server 116. The IoT device 102 then computes a cryptographic hash of the response (e.g., using an algorithm such as SHA256) and then encrypts that hash with its private encryption key. The IoT device 102 sends both this response and the encrypted hash of the response (i.e. the signature) to the authentication server 116. The IoT server 102 also sends the certificate 114 that contains the public encryption key corresponding to the private encryption key.

The authentication server 116 verifies that it accepts the certificate 114. In the illustrated example, for instance, the authentication server 116 compares the digital certificate 114 received from the IoT device 102 to a digital certificate previously added to its allow list (this verification might also include standard validity checks as described by IETF RFC 5280).

If the authentication server 116 accepts the certificate 114, it computes its own hash of the response from the IoT device 102 (not including the signature) and uses the public encryption key to decrypt the signature provided by the IoT device 102. The authentication server 114 then compares the decrypted value to the hash it has computed. If they match, the authentication server 116 determines that the IoT device 102 possesses the private encryption key corresponding to the certificate 114, the authentication server 116 authenticates the IoT device 102 on the WLAN 112.

Once the IoT device 102 has been authenticated on the WLAN 104, the IoT device 102 can establish connections to certain network services, such as network services accessible by way of the internet. In order for the IoT device 102 to authenticate with such a network service, the manufacturer 108 of the IoT device 102 stores another client digital certificate 118 (referred to herein as the “digital certificate 118”) in the memory of the IoT device 102, also at the time the device 102 is manufactured. The digital certificate 118 might, for example, be an X.509 certificate.

Information about the digital certificate 118, such as a thumbprint 124 of the digital certificate 118, can also be separately provided to the network service to be accessed. The thumbprint 124 is a hexadecimal string that uniquely identifies the digital certificate 118. As described in greater detail below, the IoT device 102 can transmit the digital certificate 118 to the network service which, in turn, can use the digital certificate 118 and the previously received information about the digital certificate 118 (e.g. the thumbprint 124) to authenticate the device 102.

In one embodiment, the IoT device 102 establishes a connection to the DPS 120 operating in the network 106 following authentication with the authentication server 116. The IoT device 102 then provides the digital certificate 118 stored in the IoT device 102 at manufacturing time to the DPS 120 for use in authenticating the IoT device 102. The DPS 120, in turn, utilizes the digital certificate 118 provided by the device 102 and the separately provided information about the digital certificate 118 (e.g. the thumbprint 124) to authenticate the device 102 using a PM authentication procedure such as that described in detail above.

If the DPS 120 can authenticate the IoT device 102, the DPS 120 then provides configuration data (not shown in FIG. 1) to the IoT device 102 for use in configuring the IoT device 102 for operation on the network services provider network 106. For instance, the configuration data might be used to configure the IoT device 102 for operation with other network services in the network services provider network 106, such as the IoT device management service 122. The IoT device 102 might also be configured to communicate with other types of network services in the network services provider network 106 in other configurations. Additional details regarding the operations described above will be provided below with regard to FIGS. 2-8.

FIG. 2 is a timing diagram showing aspects of the configuration of an IoT device 102 implementing the disclosed technologies at manufacturing time, according to one embodiment disclosed herein. As shown in FIG. 2 and described briefly above, the manufacturer 108 of the IoT device 102 obtains a root certificate 111 from a certificate authority 202. The manufacturer 108 then stores the root certificate 111 in a memory of the IoT device 102 when the device 102 is manufactured.

As also discussed above, the manufacturer 108 also stores the digital certificate 114 and the digital certificate 118 in the memory of the IoT device 102 at manufacturing time. The manufacturer 108 also stores public/private encryption keypairs 208 and 206 for the digital certificates 114 and 118, respectively, in the memory of the IoT device 102 at manufacturing time. This data might be stored in a secure enclave or another type of secure location in the IoT device 102.

Additionally, and as also described above, the manufacturer 108 can also store data 110 in the memory of the device 102 defining an SSID for a WLAN that the IoT device 102 is to establish a connection to in order to configure itself in the manner described herein. The manufacturer 108 might also store the network address or fully qualified domain name (“FQDN”) 210 of the DPS 120 for use by the IoT device 102 when connecting to the DPS 120. Details regarding the use of the data stored by the manufacturer 108 in the memory of the IoT device 102 at manufacturing time will be described in detail below.

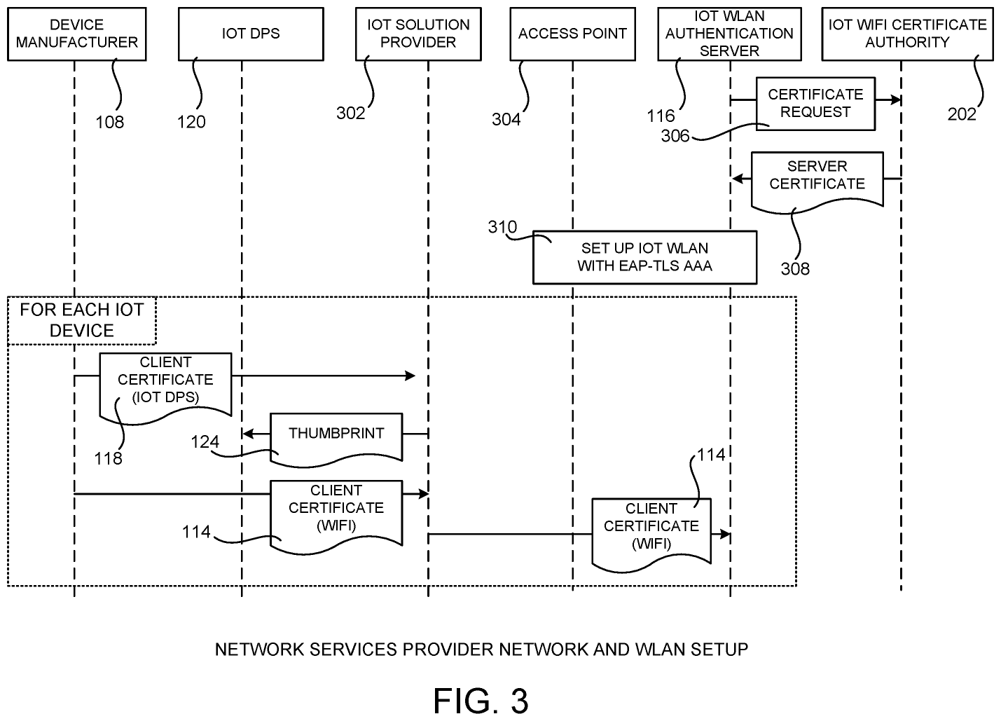

FIG. 3 is a timing diagram showing aspects of the configuration of a WLAN 104 and a network services provider network 106 implementing aspects of the disclosed technologies, according to one embodiment disclosed herein. As shown in FIG. 3, the authentication server 116 can make a request 306 for a server digital certificate 308 from the certificate authority 202. Subsequently, the WLAN 104, including associated access points 304, can be configured for EAP-TLS authentication (or another suitable authentication protocol) at operation 310. Moreover, the WLAN 104 can be configured to utilize the same SSID 112 as the SSID defined by the data 110 stored in the IoT device 102.

As shown in FIG. 3, the device manufacturer 108 also provides the digital certificate 118 to an IoT solution provider 302 associated with the WLAN 104 in one embodiment. The IoT solution provider 302, in turn, generates a thumbprint 124 of the certificate 118 and provides the thumbprint 124 to the IoT DPS 120.

The device manufacturer 108 also provides the digital certificate 114 to the IoT solution provider 302 in one embodiment. The IoT solution provider 302 then adds the digital certificate 114 to an allow list utilized by the authentication server 116.

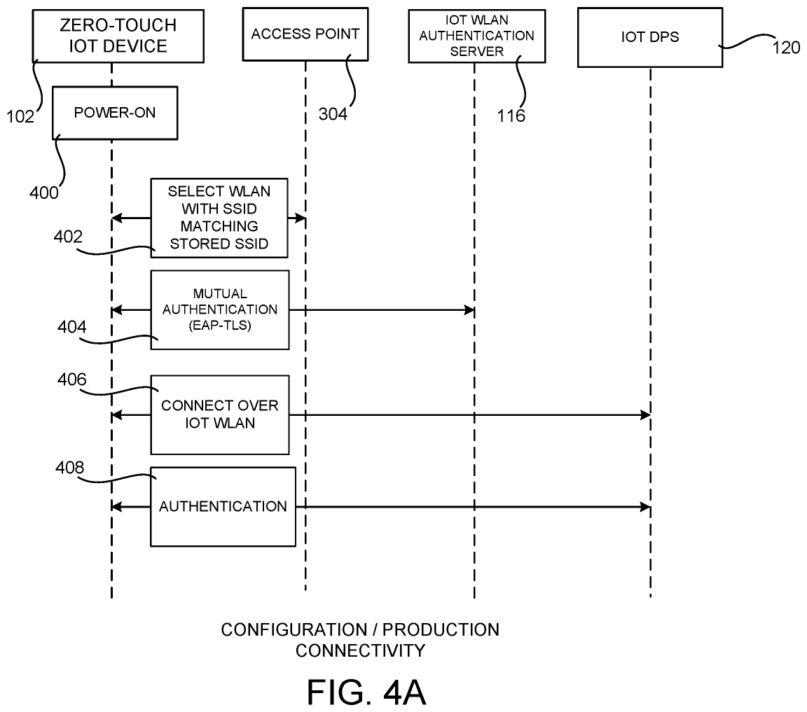

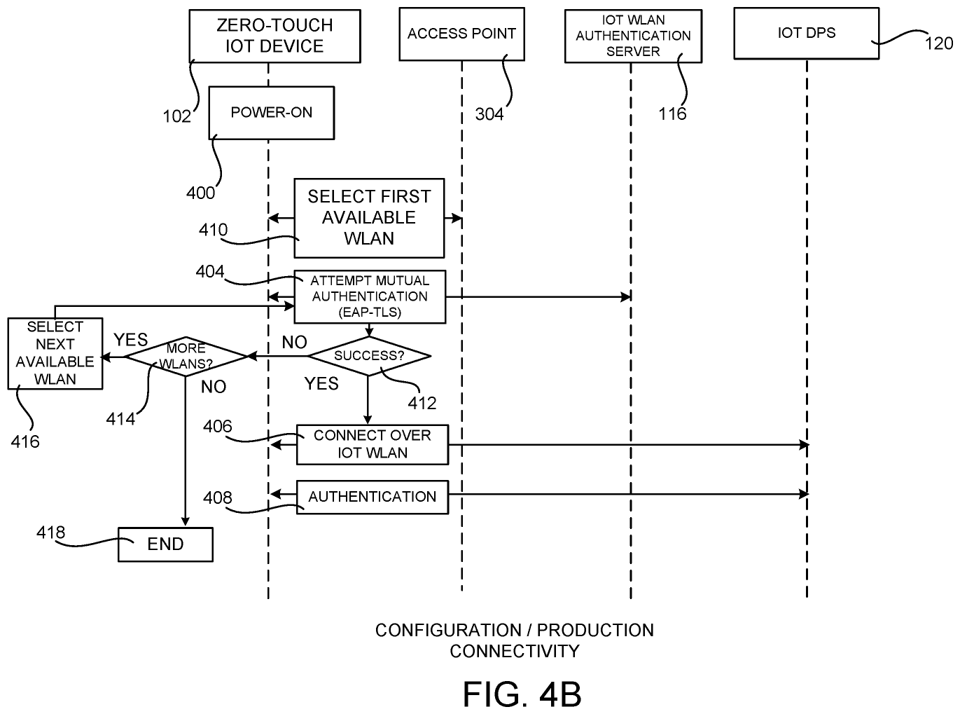

FIG. 4A is a timing diagram showing aspects of the operation of an IoT device 102 to enable connectivity to the WLAN 104, according to one embodiment disclosed herein. As shown in FIG. 4A, the IoT device 102 powers on at operation 400 and attempts to locate a WLAN 104 with an SSID 112 matching the SSID stored in the IoT device 102 at manufacturing time at operation 402. If a WLAN 104 with a matching SSID 112 is located, the IoT device 102 connects to the WLAN 104. The IoT device 102 then performs mutual authentication (e.g. EAP-TLS authentication) with the authentication server 116 at operation 404 using a PM authentication procedure such as that described in detail above.

Once authenticated, the IoT device 102 connects to the DPS 120 over the WLAN 104 at operation 406. The routine 400 then proceeds to operation 408, where the IoT device 102 then authenticates with the DPS 120 using the certificate 118 in a PM authentication procedure such as that described in detail above. Once authenticated with the DPS 120, the IoT device 102 can be configured for operation with the network 106, including network services such as the IoT device management service 122.

FIG. 4B is a timing diagram showing aspects of the configuration of an IoT device 102 to enable connectivity to the WLAN 104, according to another embodiment disclosed herein. The embodiment illustrated in FIG. 4B might be utilized in environments where an IoT device 102 is in range of more than one WLAN that provides the SSID 112. In this scenario, the IoT device 102 will be identified in the allow list of only one authentication server 116. As a result, the IoT device 102 might select the wrong WLAN (i.e. a WLAN with an authentication server 116 that does not have the certificate 114 for the device) and fail to authenticate. Further, some enterprises might not wish to deploy a WLAN with a global SSID 112. The embodiment shown in FIG. 4B addresses these technical challenges.

As shown in FIG. 4B, the IoT device 102 powers on at operation 400. The device 102 then identifies the available WLANs 104 and selects the first available WLAN at operation 410. The device 102 then attempts mutual authentication with the authentication server 116 using a PM authentication procedure such as that described in detail above. The device 102 then determines if authentication was successful at operation 412. If authentication was successful, then the device 102 connects to the DPS 120 at operation 406 and authenticates with the DPS 120 at operation 408, also in the manner described above.

If authentication was not successful, the IoT device 102 determines if additional WLANs are available upon which to attempt authentication. If so, the device 102 selects the next available WLAN at operation 416 and attempts to perform mutual authentication with an authentication server on the WLAN at operation 404. If no additional WLANs exist, the ends the process described above at operation 418. In this case, the IoT device 102 will not be authenticated on an WLAN.

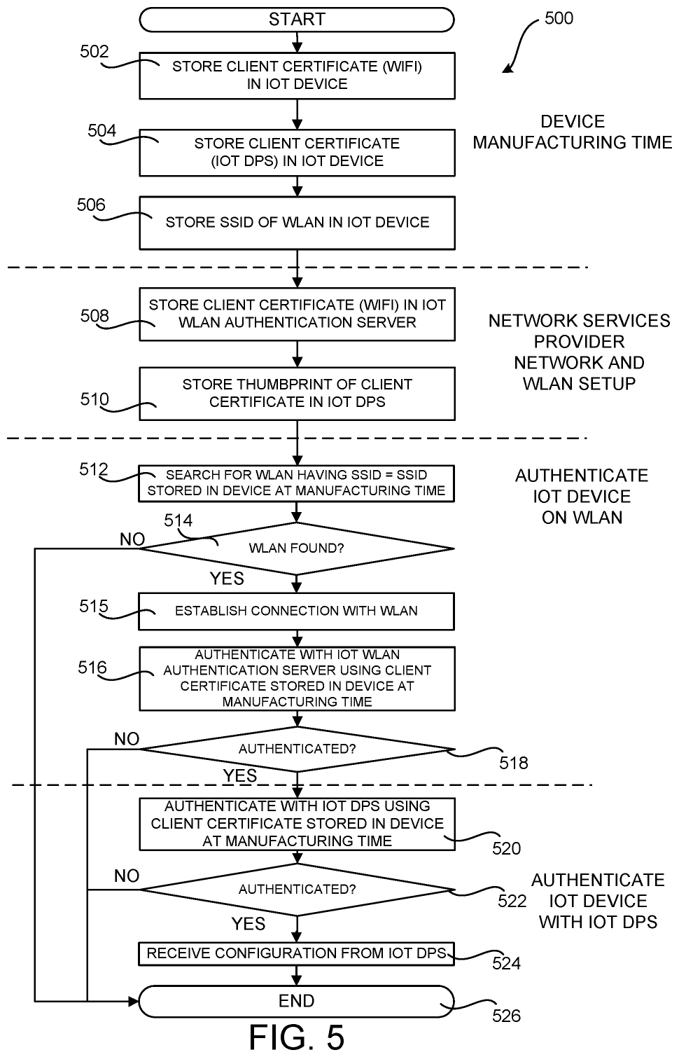

FIG. 5 is a flow diagram showing a routine 500 that illustrates aspects of the operation of the IoT device 102, the authentication server 116, and the DPS 120, described above with reference to FIGS. 1-4B for zero-touch provisioning of the IoT device 102, according to one embodiment. It should be appreciated that the logical operations described herein with regard to FIG. 5, and the other FIGS., can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein. It should also be understood that the methods described herein can be ended at any time and need not be performed in their entireties.

Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules might be implemented in software, in firmware, in special purpose digital logic, and any combination thereof

As described herein, in conjunction with the FIGS. described herein, the operations of the routine 500 are described herein as being implemented, at least in part, by an application, component, and/or circuit. Although the following illustration refers to the components of FIG. 1, it can be appreciated that the operations of the routine 500 might be also implemented in many other ways. For example, the routine 500 might be implemented, at least in part, by a computer processor or a processor or processors of another computer. In addition, one or more of the operations of the routine 500 might alternatively or additionally be implemented, at least in part, by a computer working alone or in conjunction with other software modules.

For example, the operations of routine 500 are described herein as being implemented, at least in part, by an application, component and/or circuit, which are generically referred to herein as modules. In some configurations, the modules can be a dynamically linked library (“DLL”), a statically linked library, functionality produced by an application programing interface (“API”), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

Although the following illustration refers to the components shown in FIG. 1, it can be appreciated that the operations of the routine 500 might be also implemented in many other ways. For example, the routine 500 might be implemented, at least in part, by a processor of another remote computer or a local computer or circuit. In addition, one or more of the operations of the routine 500 might alternatively or additionally be implemented, at least in part, by a chipset working alone or in conjunction with other software modules. Any service, circuit or application suitable for providing the techniques disclosed herein can be used in operations described herein.

The routine 500 begins at operation 502, where the certificate 114 used during authentication with the authentication sever 116 is stored in a memory of the IoT device 102. The routine 500 proceeds from operation 502 to operation 504, where the certificate 118 used during authentication with the DPS 120 is stored in the memory of the IoT device 102.

The routine 500 then proceeds from operation 504 to operation 506 where data 110 is stored in the memory of the IoT device 102 identifying the WLAN 104 that the IoT device 102 is to connect to. As discussed above, other information such as an FQDN 210, keypair 206, and keypair 208 can also be stored in the memory of the IoT device 102. As also discussed above, the manufacturer of the device 102 can store this data in the memory of the IoT device 102 at the time the device is manufactured.

From operation 506, the routine 500 proceeds to operation 508, where the certificate 114 is stored in the allow list maintained by the authentication server 116. The routine 500 then proceeds to operation 510, where a thumbprint 124 of the certificate 118 is provided to the DPS 120 for use in authenticating the device 102. The routine 500 then proceeds from operation 510 to operation 512.

Following deployment and power-on of the device 102, the device 102 searches for a WLAN 104 having an SSID 112 that is the same as the SSID stored in the device 102 at manufacturing time. Alternately, the device 102 can utilize the mechanism described above with regard to FIG. 5B to select from a number of available SSIDs.

If the device 102 cannot locate a WLAN 104 having a matching SSID, the routine 500 proceeds from operation 514 to operation 526, where it ends. In this case, the device 102 will not be configured for communication via the WLAN 104. If, however, the device 102 does locate a WLAN 102 with a matching SSID, the routine 500 proceeds from operation 514 to operation 515.

At operation 515, the device 102 establishes a connection to the authentication server 116 on the WLAN. The routine 500 then proceeds to operation 516, where the IoT device 102 attempts to authenticate with the authentication server 116 using the certificate 114 stored on the device 102 at manufacturing time in the manner described above.

If the device 102 cannot successfully authenticate with the authentication server 116, the routine 500 proceeds from operation 518 to operation 526, where it ends. In this case, the device 102 will not be configured for communication via the WLAN 104.

If the device 102 successfully authenticates with the authentication server 116, the routine 500 proceeds from operation 518 to operation 520. At operation 520, the device 102 attempts to authenticate with the DPS 120 using the certificate 118 stored in the device 102 at manufacturing time in the manner described above. If the device 102 does not successfully authenticate with the DPS 120, the routine 500 proceeds from operation 522 to operation 526, where it ends. In this case, the device 102 will be unable to utilize network services provided by the network 106.

If the device 102 successfully authenticates with the DPS 120 at operation 520, the routine 500 proceeds from operation 522 to operation 524. At operation 524, the DPS 120 provides the device 102 with configuration information. When the configuration information is applied to the device 102, the device 102 becomes capable of utilizing network services on the network 106, such as the device management service 122. From operation 524, the routine 500 proceeds to operation 526, where it ends.

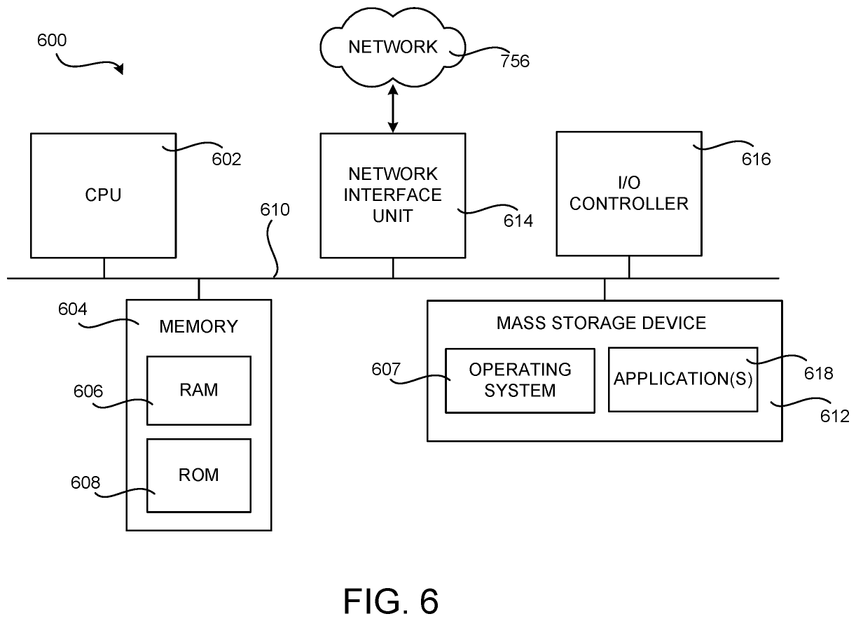

FIG. 6 shows additional details of an example computer architecture 600 for a computer, such as the IoT device 102 of executing the program components described herein. The computer architecture shown in FIG. 6 might also be utilized to implement the authentication server 116 and computing devices within the services provider network 106. Thus, the computer architecture 600 illustrated in FIG. 6 illustrates an architecture for a server computer, smartphone, a desktop computer, a tablet computer, an on-board computer, and/or a laptop computer. The computer architecture 600 can also be utilized to implement IoT devices such as, but not limited to, but are not limited to, connected security systems, thermostats, cars, electronic appliances, lights in household and commercial environments, alarm clocks, speaker systems, vending machines, voice-driven devices, and others. The computer architecture 600 might be utilized to execute any aspects of the software components presented herein.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A firmware containing the basic routines that help to transfer information between elements within the computer architecture 600, such as during startup, can be stored in the ROM 608. The computer architecture 600 further includes a mass storage device 612 for storing an operating system 607, data, and one or more application programs 618. The memory 604 and/or the mass storage device 612 can also store the IoT WLAN SSID 110, the client certificate 114, and the client certificate 118. As discussed above, these items can be stored in the IoT device 102 at manufacturing time.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media might include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes the claims, the phrase “computer storage medium,” “computer-readable storage medium” and variations thereof, does not include waves, signals, and/or other transitory and/or intangible communication media, per se.

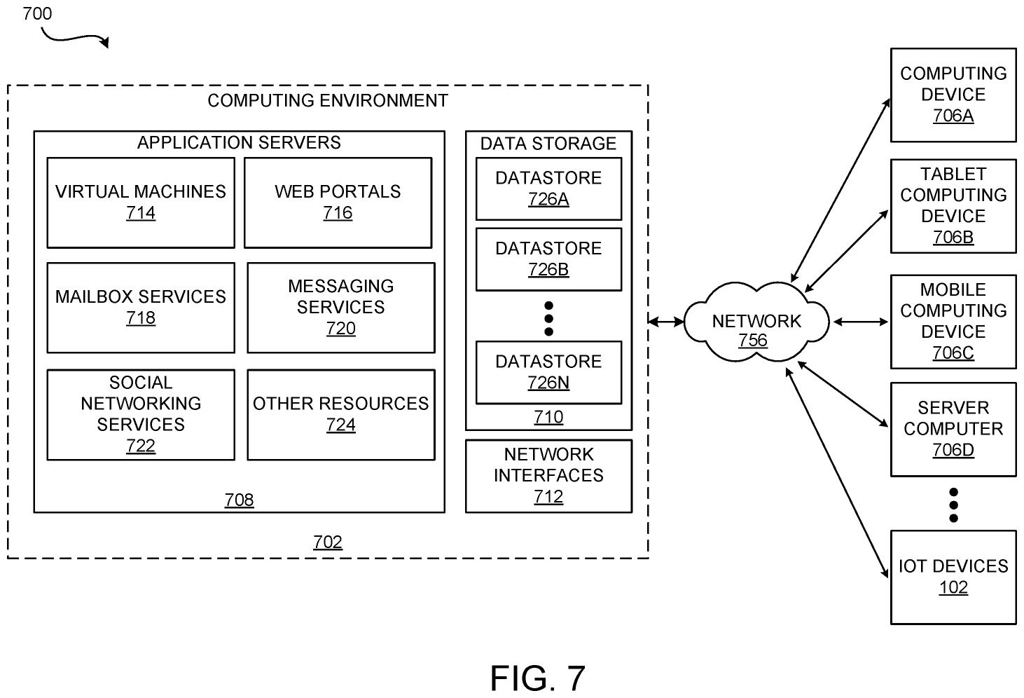

According to various configurations, the computer architecture 600 might operate in a networked environment using logical connections to remote computers through the network 756 (discussed below with regard to FIG. 7) and/or another network or networks such as those shown in FIG. 1 and described above). A computing device implementing the computer architecture 600 might connect to the network 756 through a network interface unit 614 connected to the bus 610. It should be appreciated that the network interface unit 614 also might be utilized to connect to other types of networks and remote computer systems. The computer architecture 600 also might include an input/output controller 616 for receiving and processing input from a number of other devices, including a keyboard, mouse, or electronic stylus (not shown in FIG. 6). Similarly, the input/output controller 616 might provide output to a display screen, a printer, or other type of output device (also not shown in FIG. 6).

It should be appreciated that the software components described herein might, when loaded into the CPU 602 and executed, transform the CPU 602 and the overall computer architecture 600 from a general-purpose computing system into a special-purpose computing system customized to facilitate the functionality presented herein. The CPU 602 might be constructed from any number of transistors or other discrete circuit elements, which might individually or collectively assume any number of states. More specifically, the CPU 602 might operate as a finite-state machine, in response to executable instructions contained within the software modules disclosed herein. These computer-executable instructions might transform the CPU 602 by specifying how the CPU 602 transitions between states, thereby transforming the transistors or other discrete hardware elements constituting the CPU 602.

Encoding the software modules presented herein might also transform the physical structure of the computer-readable media presented herein. The specific transformation of physical structure might depend on various factors, in different implementations of this description. Examples of such factors might include, but are not limited to, the technology used to implement the computer-readable media, whether the computer-readable media is characterized as primary or secondary storage, and the like. For example, if the computer-readable media is implemented as semiconductor-based memory, the software disclosed herein might be encoded on the computer-readable media by transforming the physical state of the semiconductor memory. For example, the software might transform the state of transistors, capacitors, or other discrete circuit elements constituting the semiconductor memory. The software also might transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of particular locations within given magnetic media. These transformations also might include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 might include other types of computing devices, including hand-held computers, embedded computer systems, personal digital assistants, and other types of computing devices known to those skilled in the art. It is also contemplated that the computer architecture 600 might not include all of the components shown in FIG. 6, might include other components that are not explicitly shown in FIG. 6, or might utilize an architecture completely different than that shown in FIG. 6.

FIG. 7 depicts an illustrative distributed computing environment 700 capable of executing the software components described herein for enabling the technologies disclosed herein for zero-touch configuration of IoT devices. Thus, computing devices in the distributed computing environment 700 illustrated in FIG. 7 can be utilized to execute any aspects of the software components presented herein.

According to various implementations, the distributed computing environment 700 includes a computing environment 702 operating on, in communication with, or as part of the network 704. The network 704 might be or might include the network 756, described above. The network 704 also can include various access networks, such as those described above with regard to FIG. 1. One or more client devices 706A-706N (hereinafter referred to collectively and/or generically as “clients 706”) can communicate with the computing environment 702 via the network 704 and/or other connections (not illustrated in FIG. 7).

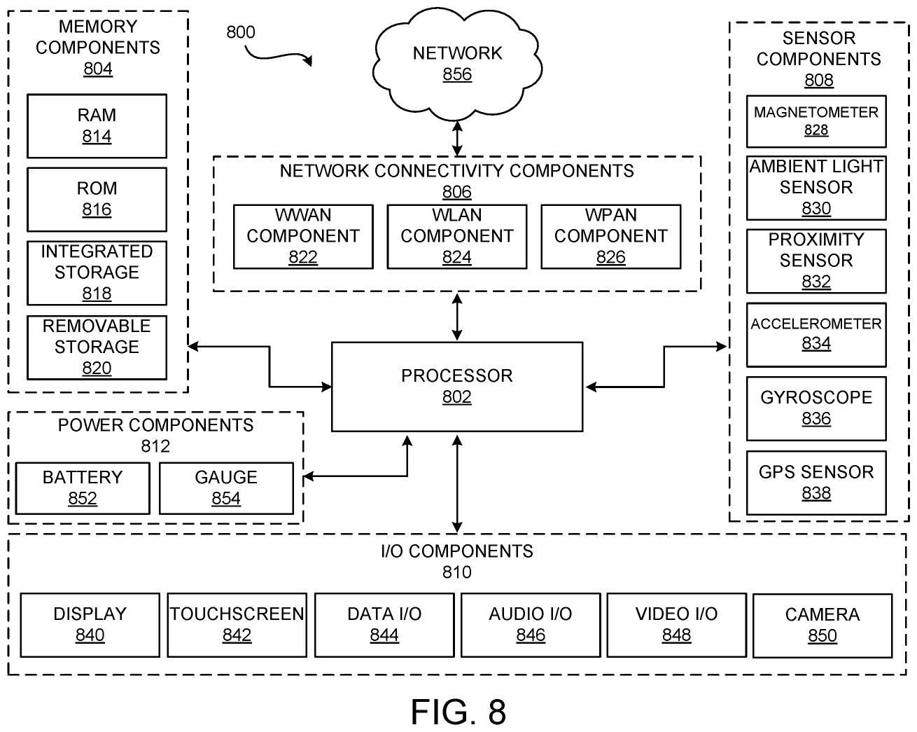

In one illustrated configuration, the clients 706 include a computing device 706A such as a laptop computer, a desktop computer, or other computing device; a tablet computing device (“tablet computing device”) 706B; a mobile computing device 706C such as a smartphone, an on-board computer, or other mobile computing device; a server computer 706D; and/or the IoT devices 102 described above. It should be understood that any number of devices 706 can communicate with the computing environment 702. Two example computing architectures for the devices 706 are illustrated and described herein with reference to FIGS. 6 and 8. It should be understood that the illustrated devices 706 and computing architectures illustrated and described herein are illustrative only, and should not be construed as being limited in any way.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 704. The application servers 708 can host various services, virtual machines, portals, and/or other resources. The application servers 708 can also host network services and other components for implementing the services provider network 106 described above.

In the illustrated configuration, the application servers 708 host one or more virtual machines 714 for hosting applications, network services, or for providing other functionality. According to various implementations, the virtual machines 714 host one or more applications and/or software modules for enabling zero-touch provisioning of IoT devices 102. It should be understood that this configuration is illustrative only, and should not be construed as being limiting in any way. The application servers 708 can also host or provide access to one or more portals, link pages, web sites, network services (e.g. the IoT Hub 122 and the IoT DPS 120), and/or other information (“web portals”) 716.

According to various implementations, the application servers 708 also include one or more mailbox services 718 and one or more messaging services 720. The mailbox services 718 can include electronic mail (“email”) services. The mailbox services 718 also can include various personal information management (“PIM”) services including, but not limited to, calendar services, contact management services, collaboration services, and/or other services. The messaging services 720 can include, but are not limited to, instant messaging services, chat services, forum services, and/or other communication services.

The application servers 708 also might include one or more social networking services 722. The social networking services 722 can include various social networking services including, but not limited to, services for sharing or posting status updates, instant messages, links, photos, videos, and/or other information; services for commenting or displaying interest in articles, products, blogs, or other resources; and/or other services. Other services are possible and are contemplated. The social networking services 722 also can include commenting, blogging, and/or micro blogging services. Other services are possible and are contemplated. As shown in FIG. 7, the application servers 708 also can host other network services, applications, portals, and/or other resources (“other resources”) 724. The other resources 724 can include, but are not limited to, document sharing, rendering, or any other functionality.

As mentioned above, the computing environment 702 can include data storage 710. According to various implementations, the functionality of the data storage 710 is provided by one or more databases operating on, or in communication with, the network 704. The functionality of the data storage 710 also can be provided by one or more server computers configured to host data for the computing environment 702. The data storage 710 can include, host, or provide one or more real or virtual data stores 726A-726N (hereinafter referred to collectively and/or generically as “datastores 726”).

The datastores 726 are configured to host data used or created by the application servers 708 and/or other data. Although not illustrated in FIG. 7, the datastores 726 also can host or store web page documents, word processing documents, presentation documents, data structures, and/or other data utilized by any application program or another module. Aspects of the datastores 726 might be associated with a service for storing files.

The computing environment 702 can communicate with, or be accessed by, the network interfaces 712. The network interfaces 712 can include various types of network hardware and software for supporting communications between two or more computing devices including, but not limited to, the clients 706 and the application servers 708. It should be appreciated that the network interfaces 712 also might be utilized to connect to other types of networks and/or computer systems.

It should be understood that the distributed computing environment 700 described herein can implement aspects of at least some of the software elements described herein with any number of virtual computing resources and/or other distributed computing functionality that can be configured to execute any aspects of the software components disclosed herein.

Turning now to FIG. 8, an illustrative computing device architecture 800 for a computing device that is capable of executing the software components described herein will be discussed. The computing device architecture 800 is applicable to computing devices that facilitate mobile computing due, in part, to form factor, wireless connectivity, and/or battery-powered operation. The computing device architecture 800 is also applicable to the IoT devices 102.

The computing device architecture 800 is applicable to any of the clients 706 shown in FIG. 7, including the IoT devices 102. Moreover, aspects of the computing device architecture 800 might be applicable to traditional desktop computers, portable computers (e.g., laptops, notebooks, ultra-portables, and netbooks), server computers, and other computer systems, such as described herein with reference to FIG. 5.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812.

Although no connections are shown between the individual components illustrated in FIG. 8, the components can interact to carry out device functions. In some configurations, the components are arranged so as to communicate via one or more hardware busses (not shown).

The processor 802 includes a central processing unit (“CPU”) configured to process data, execute computer-executable instructions of one or more application programs, and communicate with other components of the computing device architecture 800 in order to perform various functionality described herein. The processor 802 might be utilized to execute aspects of the software components presented herein and, particularly, software components for implementing the functionality provided by the IoT devices 102, the authentication server 116, and the services provider network 106.

In some configurations, the processor 802 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, 4K, and higher resolution), video games, three-dimensional (“3D”) modeling applications, and the like. In some configurations, the processor 802 is configured to communicate with a discrete GPU (not shown). In any case, the CPU and GPU might be configured in accordance with a co-processing CPU/GPU computing model, wherein the sequential part of an application executes on the CPU and the computationally-intensive part is accelerated by the GPU.

In some configurations, the processor 802 is, or is included in, a system-on-chip (“SoC”) along with one or more of the other components described herein below. For example, the SoC might include the processor 802, a GPU, one or more of the network connectivity components 806, and one or more of the sensor components 808. In some configurations, the processor 802 is fabricated, in part, utilizing a package-on-package (“PoP”) integrated circuit packaging technique. The processor 802 might be a single core or multi-core processor.

The processor 802 might implement an ARM architecture, available for license from ARM HOLDINGS of Cambridge, United Kingdom. Alternatively, the processor 802 might implement an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a RAM 814, a ROM 816, an integrated storage memory (“integrated storage”) 818, and a removable storage memory (“removable storage”) 820. In some configurations, the RAM 814 or a portion thereof, the ROM 816 or a portion thereof, and/or some combination of the RAM 814 and the ROM 816 is integrated in the processor 802. In some configurations, the ROM 816 is configured to store a firmware, an operating system or a portion thereof (e.g., operating system kernel), and/or a bootloader to load an operating system kernel from the integrated storage 818 and/or the removable storage 820. The firmware can implement operations performed by the IoT devices 102 described above. These operations can be performed when the IoT devices 102 are powered on or perform a warm reset.

The integrated storage 818 can include a solid-state memory, a hard disk, or a combination of solid-state memory and a hard disk. The integrated storage 818 might be soldered or otherwise connected to a logic board upon which the processor 802 and other components described herein also might be connected. As such, the integrated storage 818 is integrated in the computing device. The integrated storage 818 is configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available as a total combined storage capacity. In some configurations, the total combined capacity of the integrated storage 818 and the removable storage 820 is shown to a user instead of separate storage capacities for the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 might be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system 607. According to various configurations, the operating system includes, but is not limited to the WINDOWS operating system from Microsoft Corporation, IOS from Apple Inc. of Cupertino, Calif., and ANDROID OS from Google Inc. of Mountain View, Calif. Other operating systems are contemplated.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from the network 856 or another network, which might be a WWAN, a WLAN 104, or a WPAN. Although only the network 856 is illustrated, the network connectivity components 806 might facilitate simultaneous communication with multiple networks, including the network 756 of FIG. 6. For example, the network connectivity components 806 might facilitate simultaneous communications with multiple networks via one or more of a WWAN, a WLAN, or a WPAN. The network 856 might also be or might include a WWAN, such as a mobile telecommunications network utilizing one or more mobile telecommunications technologies to provide voice and/or data services to a computing device utilizing the computing device architecture 800 via the WWAN component 822.

In some configurations, the WWAN component 822 is configured to provide dual-multi-mode connectivity to the network 856. For example, the WWAN component 822 might be configured to provide connectivity to the network 856, wherein the network 856 provides service via GSM and UMTS technologies, or via some other combination of technologies. Alternatively, multiple WWAN components 822 might be utilized to perform such functionality, and/or provide additional functionality to support other non-compatible technologies (i.e., incapable of being supported by a single WWAN component). The WWAN component 822 might facilitate similar connectivity to multiple networks (e.g., a UMTS network and an LTE network).

The network 856 might be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 856 via the WI-FI access points. Such connections might be secured via various encryption technologies including, but not limited to, WI-FI Protected Access (“WPA”), WPA2, Wired Equivalent Privacy (“WEP”), and the like.

The network 856 might be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 828, an ambient light sensor 830, a proximity sensor 832, an accelerometer 834, a gyroscope 836, and a Global Positioning System sensor (“GPS sensor”) 838. It is contemplated that other sensors, such as, but not limited to, temperature sensors or shock detection sensors, also might be incorporated in the computing device architecture 800.

The magnetometer 828 is configured to measure the strength and direction of a magnetic field. In some configurations the magnetometer 828 provides measurements to a compass application program stored within one of the memory components 804 in order to provide a user with accurate directions in a frame of reference including the cardinal directions, north, south, east, and west. Similar measurements might be provided to a navigation application program that includes a compass component. Other uses of measurements obtained by the magnetometer 828 are contemplated.

The ambient light sensor 830 is configured to measure ambient light. In some configurations, the ambient light sensor 830 provides measurements to an application program stored within one of the memory components 804 in order to automatically adjust the brightness of a display (described below) to compensate for low-light and high-light environments. Other uses of measurements obtained by the ambient light sensor 830 are contemplated.

The proximity sensor 832 is configured to detect the presence of an object or thing in proximity to the computing device without direct contact. In some configurations, the proximity sensor 832 detects the presence of a user's body (e.g., the user's face) and provides this information to an application program stored within one of the memory components 804 that utilizes the proximity information to enable or disable some functionality of the computing device. For example, a telephone application program might automatically disable a touchscreen (described below) in response to receiving the proximity information so that the user's face does not inadvertently end a call or enable/disable other functionality within the telephone application program during the call. Other uses of proximity as detected by the proximity sensor 832 are contemplated.

The accelerometer 834 is configured to measure proper acceleration. In some configurations, output from the accelerometer 834 is used by an application program as an input mechanism to control some functionality of the application program. For example, the application program might be a video game in which a character, a portion thereof, or an object is moved or otherwise manipulated in response to input received via the accelerometer 834. In some configurations, output from the accelerometer 834 is provided to an application program for use in switching between landscape and portrait modes, calculating coordinate acceleration, or detecting a fall. Other uses of the accelerometer 834 are contemplated.

The gyroscope 836 is configured to measure and maintain orientation. In some configurations, output from the gyroscope 836 is used by an application program as an input mechanism to control some functionality of the application program. For example, the gyroscope 836 can be used for accurate recognition of movement within a 3D environment of a video game application or some other application. In some configurations, an application program utilizes output from the gyroscope 836 and the accelerometer 834 to enhance control of some functionality of the application program. Other uses of the gyroscope 836 are contemplated.

The GPS sensor 838 is configured to receive signals from GPS satellites for use in calculating a location. The location calculated by the GPS sensor 838 might be used by any application program that requires or benefits from location information. For example, the location calculated by the GPS sensor 838 might be used with a navigation application program to provide directions from the location to a destination or directions from the destination to the location. Moreover, the GPS sensor 838 might be used to provide location information to an external location-based service, such as E911 service. The GPS sensor 838 might obtain location information generated via WI-FI, WIMAX, and/or cellular triangulation techniques utilizing one or more of the network connectivity components 806 to aid the GPS sensor 838 in obtaining a location fix. The GPS sensor 838 might also be used in Assisted GPS (“A-GPS”) systems.

The I/O components 810 include a display 840, a touchscreen 842, a data I/O interface component (“data I/O”) 844, an audio I/O interface component (“audio I/O”) 846, a video I/O interface component (“video I/O”) 848, and a camera 850. In some configurations, the display 840 and the touchscreen 842 are combined. In some configurations two or more of the data I/O component 844, the audio I/O component 846, and the video I/O component 848 are combined. The I/O components 810 might include discrete processors configured to support the various interfaces described below, or might include processing functionality built-in to the processor 802.

The display 840 is an output device configured to present information in a visual form. In particular, the display 840 might present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 840 is a liquid crystal display (“LCD”) utilizing any active or passive matrix technology and any backlighting technology (if used). In some configurations, the display 840 is an organic light emitting diode (“OLED”) display. Other display types are contemplated.

The touchscreen 842, also referred to herein as a “touch-enabled screen,” is an input device configured to detect the presence and location of a touch. The touchscreen 842 might be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or might utilize any other touchscreen technology. In some configurations, the touchscreen 842 is incorporated on top of the display 840 as a transparent layer to enable a user to use one or more touches to interact with objects or other information presented on the display 840. In other configurations, the touchscreen 842 is a touch pad incorporated on a surface of the computing device that does not include the display 840. For example, the computing device might have a touchscreen incorporated on top of the display 840 and a touch pad on a surface opposite the display 840.

In some configurations, the touchscreen 842 is a single-touch touchscreen. In other configurations, the touchscreen 842 is a multi-touch touchscreen. In some configurations, the touchscreen 842 is configured to detect discrete touches, single touch gestures, and/or multi-touch gestures. These are collectively referred to herein as gestures for convenience. Several gestures will now be described. It should be understood that these gestures are illustrative only and are not intended to limit the scope of the appended claims. Moreover, the described gestures, additional gestures, and/or alternative gestures might be implemented in software for use with the touchscreen 842. As such, a developer might create gestures that are specific to a particular application program.

In some configurations, the touchscreen 842 supports a tap gesture in which a user taps the touchscreen 842 once on an item presented on the display 840. The tap gesture might be used for various reasons including, but not limited to, opening or launching whatever the user taps. In some configurations, the touchscreen 842 supports a double tap gesture in which a user taps the touchscreen 842 twice on an item presented on the display 840. The double tap gesture might be used for various reasons including, but not limited to, zooming in or zooming out in stages. In some configurations, the touchscreen 842 supports a tap and hold gesture in which a user taps the touchscreen 842 and maintains contact for at least a pre-defined time. The tap and hold gesture might be used for various reasons including, but not limited to, opening a context-specific menu.

In some configurations, the touchscreen 842 supports a pan gesture in which a user places a finger on the touchscreen 842 and maintains contact with the touchscreen 842 while moving the finger on the touchscreen 842. The pan gesture might be used for various reasons including, but not limited to, moving through screens, images, or menus at a controlled rate. Multiple finger pan gestures are also contemplated. In some configurations, the touchscreen 842 supports a flick gesture in which a user swipes a finger in the direction the user wants the screen to move. The flick gesture might be used for various reasons including, but not limited to, scrolling horizontally or vertically through menus or pages. In some configurations, the touchscreen 842 supports a pinch and stretch gesture in which a user makes a pinching motion with two fingers (e.g., thumb and forefinger) on the touchscreen 842 or moves the two fingers apart. The pinch and stretch gesture might be used for various reasons including, but not limited to, zooming gradually in or out of a web site, map, or picture.

Although the above gestures have been described with reference to the use one or more fingers for performing the gestures, other appendages such as toes or objects such as styluses might be used to interact with the touchscreen 842. As such, the above gestures should be understood as being illustrative only and should not be construed as being limiting in any way.

The data I/O interface component 844 is configured to facilitate input of data to the computing device and output of data from the computing device. In some configurations, the data I/O interface component 844 includes a connector configured to provide wired connectivity between the computing device and a computer system, for example, for synchronization operation purposes. The connector might be a proprietary connector or a standardized connector such as USB, micro-USB, mini-USB, USB-C or the like. In some configurations, the connector is a dock connector for docking the computing device with another device such as a docking station, audio device (e.g., a digital music player), or video device.

The audio I/O interface component 846 is configured to provide audio input and/or output capabilities to the computing device. In some configurations, the audio I/O interface component 846 includes a microphone configured to collect audio signals. In some configurations, the audio I/O interface component 846 includes a headphone jack configured to provide connectivity for headphones or other external speakers. In some configurations, the audio I/O interface component 846 includes a speaker for the output of audio signals. In some configurations, the audio I/O interface component 846 includes an optical audio cable out.

The video I/O interface component 848 is configured to provide video input and/or output capabilities to the computing device. In some configurations, the video I/O interface component 848 includes a video connector configured to receive video as input from another device (e.g., a video media player such as a DVD or BLURAY player) or send video as output to another device (e.g., a monitor, a television, or some other external display). In some configurations, the video I/O interface component 848 includes a High-Definition Multimedia Interface (“HDMI”), mini-HDMI, micro-HDMI, DisplayPort, or proprietary connector to input/output video content. In some configurations, the video I/O interface component 848 or portions thereof is combined with the audio I/O interface component 846 or portions thereof. The device illustrated in FIG. 8 can also be headless (i.e. without a display).

The camera 850 can be configured to capture still images and/or video. The camera 850 might utilize a charge coupled device (“CCD”) or a complementary metal oxide semiconductor (“CMOS”) image sensor to capture images. In some configurations, the camera 850 includes a flash to aid in taking pictures in low-light environments. Settings for the camera 850 might be implemented as hardware or software buttons.

Although not illustrated, one or more hardware buttons might also be included in the computing device architecture 800. The hardware buttons might be used for controlling some operational aspects of the computing device. The hardware buttons might be dedicated buttons or multi-use buttons. The hardware buttons might be mechanical or sensor-based.

The illustrated power components 812 include one or more batteries 852, which can be connected to a battery gauge 854. The batteries 852 might be rechargeable or disposable. Rechargeable battery types include, but are not limited to, lithium polymer, lithium ion, nickel cadmium, and nickel metal hydride. Each of the batteries 852 might be made of one or more cells.

The battery gauge 854 can be configured to measure battery parameters such as current, voltage, and temperature. In some configurations, the battery gauge 854 is configured to measure the effect of a battery's discharge rate, temperature, age and other factors to predict remaining life within a certain percentage of error. In some configurations, the battery gauge 854 provides measurements to an application program that is configured to utilize the measurements to present useful power management data to a user. Power management data might include one or more of a percentage of battery used, a percentage of battery remaining, a battery condition, a remaining time, a remaining capacity (e.g., in watt hours), a current draw, and a voltage.

The power components 812 might also include a power connector, which might be combined with one or more of the aforementioned I/O components 810. The power components 812 might interface with an external power system or charging equipment via an I/O component.

It is to be appreciated that the computing architectures and networks shown in FIGS. 6-8 have been simplified for ease of discussion. It should also be appreciated that the disclosed computing architectures and networks can include and utilize more, less, different, or alternate computing components, devices, software programs, networking devices, and other components not specifically described herein.

The disclosure presented herein also encompasses the subject matter set forth in the following clauses:

Clause 1. A computer-implemented method performed by a computing device, the method comprising: determining if a wireless local area network (WLAN) is available that has a service set identifier (SSID) that matches an SSID stored in a memory of the computing device at a time the computing device was manufactured; responsive to determining that a WLAN is available that has an SSID matching the SSID stored in the memory of the computing device at the time the computing device was manufactured, establishing a connection to the WLAN, and authenticating on the WLAN by providing a digital certificate stored in the memory of the computing device at the time the computing device was manufactured to an authentication server , wherein the digital certificate was previously stored at the authentication server, and wherein the authentication server authenticates the computing device on the WLAN using the digital certificate.

Clause 2. The computer-implemented method of clause 1, further comprising: establishing a connection to a network service by way of the wireless local area network; and authenticating the computing device with the network service by providing a second digital certificate to the network service, wherein the second digital certificate was stored in the memory of the computing device at the time the computing device was manufactured.

Clause 3. The computer-implemented method of any of clauses 1 or 2, wherein the network service comprises a device provisioning service operating in a network services provider network, and wherein the method further comprises: receiving configuration data from the device provisioning service, the configuration data defining a configuration for the computing device for operation with the network services provider network; and configuring the computing device for operation with the network services provider network using the configuration data.

Clause 4. The computer-implemented method of any of clauses 1-3, further comprising establishing a connection between the computing device and a second network service in the network services provider network following the configuration of the computing device.

Clause 5. The computer-implemented method of any of clauses 1-4, wherein the authentication server is connected to a network services provider network.

Clause 6. The computer-implemented method of any of clauses 1-5, wherein the authentication server is connected to the wireless local area network.

Clause 7. A computer-implemented method performed by a computing device, the method comprising: storing a digital certificate on a computer-readable storage medium of the computing device; receiving a digital certificate from a second computing device connected to the computing device by way of a WLAN, wherein the digital certificate received from the second computing device was stored in a memory of the second computing device at a time the second computing device was manufactured, and wherein the WLAN has a service set identifier (SSID) the same as an SSID stored in the memory of the second computing device at the time the second computing device was manufactured; comparing the digital certificate received from the second computing device to the digital certificate stored in the memory of the computing device; and authenticating the second computing device based upon a result of the comparison.

Clause 8. The computer-implemented method of clause 7, wherein the second computing device is further configured to: establish a connection to a network service by way of the wireless local area network following authentication; and authenticate with the network service by providing a second digital certificate to the network service, wherein the second digital certificate was stored in the memory of the second computing device at the time the computing device was manufactured.

Clause 9. The computer-implemented method of any of clauses 7 or 8, wherein the network service comprises a device provisioning service operating in a network services provider network.

Clause 10. The computer-implemented method of any of clauses 7-9, wherein the second computing device is further configured to: receive configuration data from the device provisioning service, the configuration data defining a configuration for the second computing device for operation with the network services provider network; and configure itself for operation with the network services provider network using the configuration data.

Clause 11. The computer-implemented method of any of clauses 7-10, wherein the second computing device is further configured to establish a connection to a second network service in the network services provider network following the configuration of the second computing device.

Clause 12. The computer-implemented method of any of clauses 7-11, wherein the computing device is connected to a network services provider network.

Clause 13. The computer-implemented method of any of clauses 7-12, wherein the computing device is connected to the wireless local area network.

Clause 14. A computing device, comprising: a processor; a network interface unit; and a computer-readable storage media having instructions stored thereupon which, when executed by the processor, cause the computing device to: determine, by way of the network interface unit, if a wireless local area network (WLAN) is available that has a service set identifier (SSID) that matches an SSID stored in a memory of the computing device at a time the computing device was manufactured; responsive to determining that a WLAN is available that has an SSID matching the SSID stored in the memory of the computing device at the time the computing device was manufactured, establish a connection to the WLAN and authenticate on the WLAN by providing a digital certificate stored in the memory of the computing device at the time the computing device was manufactured to an authentication server, wherein the digital certificate was previously stored at the authentication server, and wherein the authentication server authenticates the computing device on the WLAN using the digital certificate.

Clause 15. The computing device of clause 14, wherein the computer-readable storage media has further instructions stored thereupon to: establish a connection to a network service by way of the wireless local area network following authentication on the wireless local area network; and authenticate the computing device with the network service by providing a second digital certificate to the network service, wherein the second digital certificate was stored in the computer-readable storage media at the time the computing device was manufactured.

Clause 16. The computing device of any of clauses 14 or 15, wherein the network service comprises a device provisioning service operating in a network services provider network, and wherein the computer-readable storage media has further instructions stored thereupon to: receive configuration data from the device provisioning service, the configuration data defining a configuration for the computing device for operation with the network services provider network; and configure the computing device for operation with the network services provider network using the configuration data.

Clause 17. The computing device of any of clauses 14-16, wherein the computer-readable storage media has further instructions stored thereupon to establish a connection between the computing device and a second network service in the network services provider network following the configuration of the computing device.

Clause 18. The computer-implemented method of any of clause 14-17, wherein the second network service comprises a device management service.

Clause 19. The computing device of any of clauses 14-18, wherein the authentication server is connected to a network services provider network.

Clause 20. The computing device of any of clauses 14-19, wherein the authentication server is connected to the wireless local area network.

Based on the foregoing, it should be appreciated that technologies have been disclosed herein for zero-touch provisioning of IoT devices. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method performed by a computing device, the method comprising:
determining if a wireless local area network (WLAN) is available that has a service set identifier (SSID) that matches an SSID stored in a memory of the computing device at a time the computing device was manufactured;
responsive to determining that a WLAN is available that has an SSID matching the S SID stored in the memory of the computing device at the time the computing device was manufactured,
establishing a connection to the WLAN, and
authenticating on the WLAN by providing a digital certificate stored in the memory of the computing device at the time the computing device was manufactured to an authentication server , wherein the digital certificate was previously stored at the authentication server, and wherein the authentication server authenticates the computing device on the WLAN using the digital certificate.

2. The computer-implemented method of claim 1, further comprising:
establishing a connection to a network service by way of the wireless local area network; and
authenticating the computing device with the network service by providing a second digital certificate to the network service, wherein the second digital certificate was stored in the memory of the computing device at the time the computing device was manufactured.

3. The computer-implemented method of claim 2, wherein the network service comprises a device provisioning service operating in a network services provider network, and wherein the method further comprises:
receiving configuration data from the device provisioning service, the configuration data defining a configuration for the computing device for operation with the network services provider network; and
configuring the computing device for operation with the network services provider network using the configuration data.

4. The computer-implemented method of claim 3, further comprising establishing a connection between the computing device and a second network service in the network services provider network following the configuration of the computing device.

5. The computer-implemented method of claim 1, wherein the authentication server is connected to a network services provider network.

6. The computer-implemented method of claim 1, wherein the authentication server is connected to the wireless local area network.

7. A computer-implemented method performed by a computing device, the method comprising:
storing a digital certificate on a computer-readable storage medium of the computing device;
receiving a digital certificate from a second computing device connected to the computing device by way of a WLAN, wherein the digital certificate received from the second computing device was stored in a memory of the second computing device at a time the second computing device was manufactured, and wherein the WLAN has a service set identifier (SSID) the same as an SSID stored in the memory of the second computing device at the time the second computing device was manufactured;
comparing the digital certificate received from the second computing device to the digital certificate stored in the memory of the computing device; and
authenticating the second computing device based upon a result of the comparison.

8. The computer-implemented method of claim 7, wherein the second computing device is further configured to:
establish a connection to a network service by way of the wireless local area network following authentication; and
authenticate with the network service by providing a second digital certificate to the network service, wherein the second digital certificate was stored in the memory of the second computing device at the time the computing device was manufactured.

9. The computer-implemented method of claim 8, wherein the network service comprises a device provisioning service operating in a network services provider network.

10. The computer-implemented method of claim 9, wherein the second computing device is further configured to:
receive configuration data from the device provisioning service, the configuration data defining a configuration for the second computing device for operation with the network services provider network; and
configure itself for operation with the network services provider network using the configuration data.

11. The computer-implemented method of claim 10, wherein the second computing device is further configured to establish a connection to a second network service in the network services provider network following the configuration of the second computing device.

12. The computer-implemented method of claim 8, wherein the computing device is connected to a network services provider network.

13. The computer-implemented method of claim 8, wherein the computing device is connected to the wireless local area network.

14. A computing device, comprising:
a processor;
a network interface unit; and
a computer-readable storage media having instructions stored thereupon which, when executed by the processor, cause the computing device to:
determine, by way of the network interface unit, if a wireless local area network (WLAN) is available that has a service set identifier (SSID) that matches an SSID stored in a memory of the computing device at a time the computing device was manufactured;
responsive to determining that a WLAN is available that has an SSID matching the S SID stored in the memory of the computing device at the time the computing device was manufactured,
establish a connection to the WLAN and
authenticate on the WLAN by providing a digital certificate stored in the memory of the computing device at the time the computing device was manufactured to an authentication server, wherein the digital certificate was previously stored at the authentication server, and wherein the authentication server authenticates the computing device on the WLAN using the digital certificate.

15. The computing device of claim 14, wherein the computer-readable storage media has further instructions stored thereupon to:
establish a connection to a network service by way of the wireless local area network following authentication on the wireless local area network; and
authenticate the computing device with the network service by providing a second digital certificate to the network service, wherein the second digital certificate was stored in the computer-readable storage media at the time the computing device was manufactured.

16. The computing device of claim 15, wherein the network service comprises a device provisioning service operating in a network services provider network, and wherein the computer-readable storage media has further instructions stored thereupon to:
receive configuration data from the device provisioning service, the configuration data defining a configuration for the computing device for operation with the network services provider network; and
configure the computing device for operation with the network services provider network using the configuration data.

17. The computing device of claim 16, wherein the computer-readable storage media has further instructions stored thereupon to establish a connection between the computing device and a second network service in the network services provider network following the configuration of the computing device.

18. The computer-implemented method of claim 17, wherein the second network service comprises a device management service.

19. The computing device of claim 14, wherein the authentication server is connected to a network services provider network.

20. The computing device of claim 14, wherein the authentication server is connected to the wireless local area network.
